(19) United States
(12) Patent Application Publication
(10) Pub. No.: US 2017/0067602 A1
(43) Pub. Date: Mar. 9, 2017

(54) GAS CYLINDER AND BUNDLE OF GAS CYLINDERS

(71) Applicants: L'AIR LIQUIDE, SOCIETE ANONYME POUR L'ETUDE ET L'EXPLOITATION DES PROCEDES GEORGES CLAUDE, Paris (FR); AIR LIQUIDE OIL AND GAS SERVICES LIMITED, Birmingham (GB); FABER INDUSTRIE S.P.A., Cividale del Friuli (UD) (IT)

(72) Inventors: Gian Luigi COLA, Venezia (IT); Emmanuel BAUNE, Saint-Prix (FR); Guillaume ARNAUD, Paris (FR); Paul BURGIN, Notts (GB); Hervé BARTHELEMY, Montevrain (FR)

(73) Assignees: L'AIR LIQUIDE, SOCIETE ANONYME POUR L'ETUDE ET L'EXPLOITATION DES PROCEDES GEORGES CLAUDE, Paris (FR); AIR LIQUIDE OIL AND GAS SERVICES LIMITED, Birmingham (GB); FABER INDUSTRIE S.P.A., Cividale del Friuli (UD) (IT)

(21) Appl. No.: 15/256,974

(22) Filed: Sep. 6, 2016

(30) Foreign Application Priority Data
Sep. 4, 2015 (EP) 15183964.4

(51) Int. Cl. F17C 13/08; F17C 13/04; F17C 1/00; F17C 13/00

(52) U.S. Cl. CPC F17C 13/08; F17C 13/002; F17C 13/04; F17C 1/00; F17C 2205/0323; F17C 2205/013; F17C 2201/0104; F17C 2205/0107; F17C 2205/0157; F17C 2270/01

(57) ABSTRACT

A gas cylinder for gas under pressure has a cylindrical body having a first end which is opened and configured to be equipped with a valve and a manifold and a second end, positioned at the opposite of the first end, the second end being closed, characterized in that the second end is a blocking and indexing member of the gas cylinder, when the gas cylinder is in a storing position in a frame.

The invention relates to the technical field of gas cylinder for gas under pressure and more particularly the fastening and holding method of the said cylinder in a frame.

To store and transport gas cylinder, it is common to used frames equipped with holding parts that are placed on the gas cylinder walls and ends and tightened via straps or tie rods or the like. Moreover gas cylinders can often be mounted adjacent to each other, inside a frame.

The document DE19935516 discloses a gas cylinder for gas under pressure comprising an upper end having a valve. The said end is configured to be equipped with a holding device serving for fixing the cylinder in a frame. The said gas cylinder also comprises fixing devices enabling auxiliary components to be fixed to the gas cylinder. In this configuration, it is necessary to add elements that allow the holding of the gas cylinder in a structure, due to the shape of the opened end that must be shaped to be equipped with a valve or a manifold. Therefore, the implementation of such added elements in the gas cylinder structure can be complicated and costly.

The purpose of the present invention is to solve whole or part of the above mentioned drawbacks.

The invention provides a gas cylinder Gas cylinder for gas under pressure comprising a cylindrical body which comprises :
a first end which is opened and configured to be equipped with a valve and a manifold and,
a second end, positioned at the opposite of the first end, the second end being closed or open,
   characterized in that the second end is a blocking and indexing member of the gas cylinder, the said second end being configured to index angularly the gas cylinder in a frame, when the said gas cylinder is in a storing position in the frame.

This indexation feature ultimately enables to index the valve exits at cylinder outlets in a manner such to facilitate the mounting of the manifold and to orient cylinders inside the bundle with respect to markings operational and/or commercial markings on gas cylinder bodies. Moreover, the indexation and the blocking of the gas cylinder by at least the second end itself are very advantageous because there is no need to add specific means or to complicate the inner structure of the gas cylinder.

According to a feature of the invention, the second end of the gas cylinder is integral with the body of the gas cylinder.

According to a feature of the invention, the second end of the gas cylinder has a non-circular cross-section. Preferentially, the second end of the gas cylinder has a polygonal cross-section with multiple branches for example shaped like a star, a cross, etc. The multiple branches of the cross-section extend radially from the second end, allowing the blocking of the cylinder in multiple directions.

The polygonal cross-section of the second end of the gas cylinder is integral with the cylinder body. The polygonal cross section is realized in one piece with the gas cylinder body.

According to a feature of the invention, the gas cylinder's body is of composite construction. Advantageously, the gas cylinder body is metallic and is wrapped in a composite layer.

According to a feature of the invention, the gas cylinder is reinforced by filament wrapping of carbon fiber and/or glass fiber and/or Kevlar® (poly (p-phénylènetéréphtalamide)).

According to a feature of the invention the gas cylinder's body's capacity is between 20 L and 450 L, and preferably more than 40 L.

According to a feature of the invention, the second end is full or hollow. Advantageously, when the second end is hollow, the gas cylinder is lighter.

In a variant of the invention, the second end is open and equipped with a valve. A gas passage is therefore enabled through the second end of gas cylinder.

According to another feature of the invention, the second end is equipped with a manifold mounted on the valve.

According to a feature of the invention, the first end is provided with a flange or a collar, the said flange being an adaptor configured for blocking without indexing the gas cylinder in the vicinity of the first end.

Preferentially, the said flange has a circular cross-section. Alternatively, the said flange has a non-circular cross-section.

According to a feature of the invention, the first end of the gas cylinder is protruding from the body of the cylinder along a longitudinal axis of the body.

According to a feature of the invention, the second end of the gas cylinder is protruding from the body of the gas cylinder along a longitudinal axis of the body.

According to a feature of the invention, the protrusion of the second end represents approximately between at least 1% and 4% or between at least 2% and 4% overall length of the gas cylinder. Preferably, the protrusion of the second end represents approximately between at least 1% and 3% or between at least 2% and 3% overall length of the gas cylinder. More preferably, the protrusion of the second end represents approximately between at least 1% and 2% overall length of the gas cylinder. Still more preferably, the protrusion of the second end represents around 2% overall length of the gas cylinder

According to a feature of the invention, the second end of the gas cylinder is provided with a flange.

According to a feature of the invention, the gas cylinder is covered by an anti-corrosion treatment.

According to a feature of the invention, the gas cylinder is covered by a finishing treatment.

According to a feature of the invention, the gas cylinder can comprise an attached foot that is fixed on the second end, in order to enable an individual gas cylinder use.

Another object of the invention is an bundle of gas cylinders comprising a frame in which at least one gas cylinder according to the invention is mounted, the said frame comprising at least one housing configured to receive the second end of the gas cylinder in order to maintain the said gas cylinder in the frame.

According to a feature of the invention, the bundle of gas cylinders comprises at least a second gas cylinder according to the invention, the second gas cylinder being mounted in the frame via its second end which is received in a second housing of the frame, the first gas cylinder and the second gas cylinder being maintained in the frame without any contact one to another.

According to a feature of the invention, the bundle of gas cylinders comprises a plurality of gas cylinders according to the invention.

According to a feature of the invention, each housing is configured to cooperate at least partially by form complementarity with a second end of a gas cylinder.

According to another feature, each housing forms a stopping and blocking of the rotation of the second end of the gas cylinder around the longitudinal axis of the said gas cylinder.

According to another feature of the invention, each housing is shaped, for example, to cooperate with the second end of the gas cylinder according to at least two angularly distinct blocking and stable positions of the gas cylinder relative to the frame around the longitudinal axis.

Advantageously, it can be more angular distinct blocking and stable positions of cooperation for example, at least two, three to ten or more.

According to a feature of the invention, the gas cylinders in the bundle are positioned without any contact with each other and aligned in two directions.

Alternately and according to a feature of the invention, the gas cylinders are positioned without any contact with each other and aligned in one direction and positioned in the second direction in quincunx.

According to a feature of the invention, each housing is spaced from each other in order to avoid any contact between the gas cylinders.

According to a feature of the invention, a locking member is positioned inside the housing in order to hold and block the position of the gas cylinder by at least the second end.

According to another feature of the invention, the frame comprises a first support comprising at least one hole configured to received the first end of at least one gas cylinder, a second support laid out approximately parallel to the first support and comprising at least one hole configured to receive the second end of the said at least one gas cylinder.

Preferentially, the first and second support are sheets metal.

According to another feature of the invention, the first support and the second support are being connected to each other by at least one rigid fixation element.

The invention will be better understood thanks to the detailed specification hereinafter, which describes several embodiments of the invention as examples and based on the following figures:

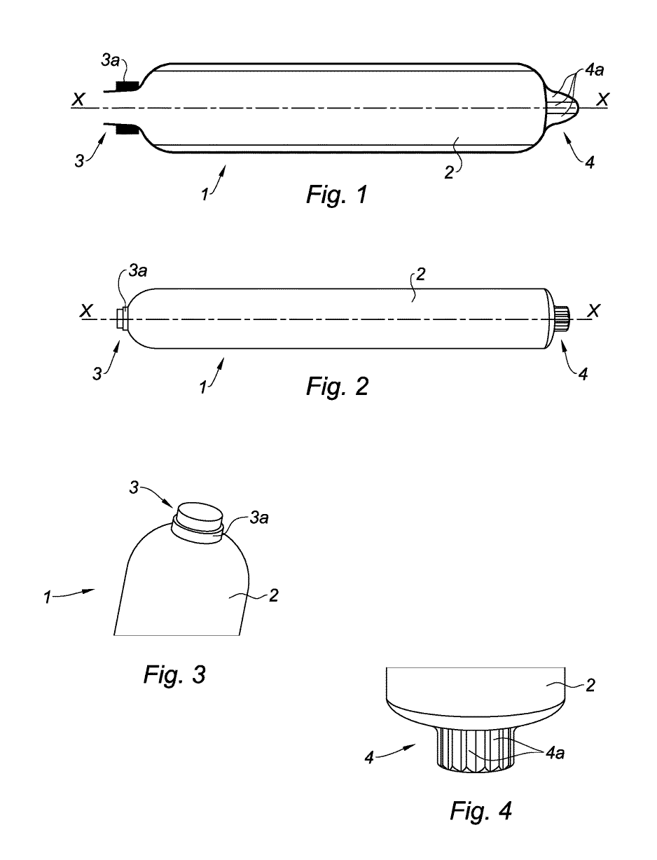

the FIG. 1 is a schematic view of the gas cylinder according to the invention,

the FIG. 2 is a side view of the said gas cylinder represented in the FIG. 1,

the FIG. 3 is a perspective view of a first embodiment of the first end of the gas cylinder represented in the FIG. 1,

the FIG. 4 is a perspective view of a first embodiment of the second end of the gas cylinder represented in the FIG. 1,

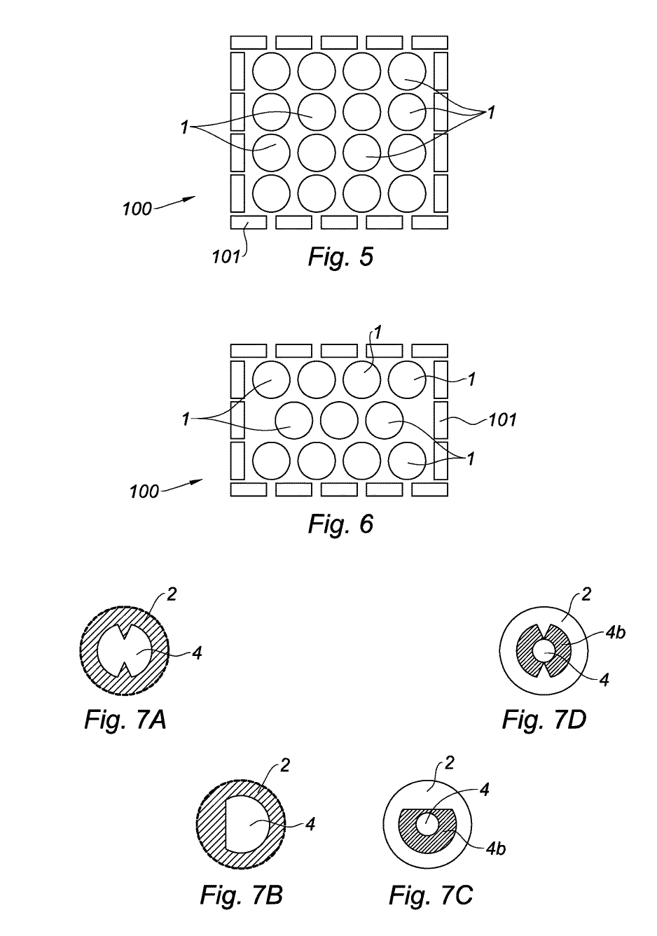

the FIG. 5 is a schematic top-view of an bundle of gas cylinders according to the invention and according to a first storing configuration,

the FIG. 6 is a schematic top-view of the bundle of gas cylinders according to the invention and according to a second storing configuration,

the FIG. 7A is a schematic bottom-view of the second end of the gas cylinder according to a first variant of the first embodiment of the second end,

the FIG. 7B is a schematic bottom-view of the second end of the gas cylinder according to a second variant of the first embodiment of the second end,

the FIG. 7C is a schematic bottom-view of the second end of the gas cylinder according to a third variant of the first embodiment of the second end,

the FIG. 7D is a schematic bottom-view of the second end of the gas cylinder according to a forth variant of the first embodiment of the second end,

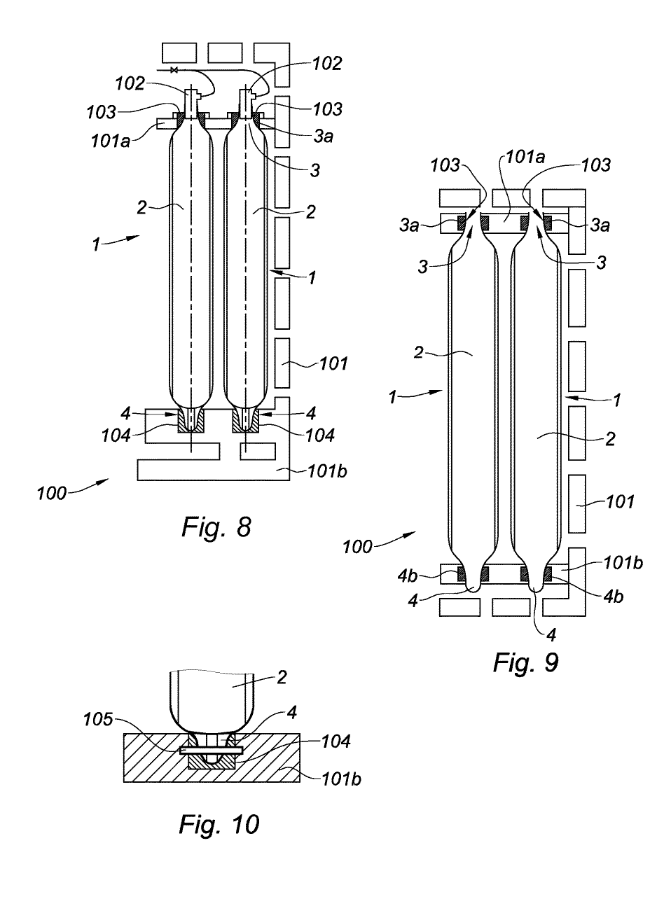

the FIG. 8 is a partial side view of the bundle according to the invention according to a first fastening of a gas cylinder and a frame,

the FIG. 9 is a partial side view of the bundle according to the invention according to a second fastening of a gas cylinder and a frame,

the FIG. 10 is a partial side view of the bundle according to the invention according to a variant of the first fastening of a gas cylinder and a frame.

As shown in the FIGS. 1 and 2, the gas cylinder 1 according to the invention comprises a cylindrical body 2 made with a composite material.

The body 2 of the gas cylinder 1 comprises a first end 3 which is opened and configured to be equipped with a valve and a manifold 102.

The first end 3 is represented in detail in FIG. 3. As shown in FIG. 3, the first end 3 has a circular cross-section and is equipped with a flange 3a. The said flange 3a is an adaptor configured for blocking without indexing the gas cylinder 1 in the vicinity of the first end 3 as seen in FIGS. 8 and 9. The flange 3a of the first end has also a circular cross-section.

A shown in FIGS. 1 and 2 for example, the body 2 of the gas cylinder 1 comprises also a closed second end 4, positioned at the opposite of the first end 3.

The second end 4 can be full or hollow. The second end 4 is a blocking and indexing member of the gas cylinder 1, when the said gas cylinder 1 is in a storing position in a frame 101 as shown in FIGS. 8 to 10 and as described later.

As shown in detail in FIG. 4, the second end 4 of the gas cylinder is protruding from the body 2 of the cylinder along a longitudinal axis X-X of the body.

Moreover, the second end 4 has a non-circular cross-section. Particularly according to a first embodiment represented in FIG. 4, the cross-section of the second end 4 is in the form of a star which comprises several branches 4a. The several branches 4a of the cross-section extend radially from the second end 4, allowing the blocking of the gas cylinder 1 in multiple directions.

In a variant of the gas cylinder 1 represented in FIG. 1, the second end 4 comprises also a flange 4b as shown in FIG. 9. In this example, the flange 4b of the second end 4 has a circular cross-section.

Several variant of the first embodiment of the second end 4 are represented in FIGS. 7A, 7B, 7C and 7D.

The FIGS. 7A and 7B show top-views of a second end 4 of a gas cylinder 1 with other shapes than in the first embodiment of the second end represented in FIG. 4.

The FIGS. 7C and 7D show top-views of a second end 4 of a gas cylinder 1 with a flange 4b, the said flange 4b having another shape than in the variant represented in FIG. 9. Indeed, in the variant represented in FIG. 9, the flange 4b of the second end 4 is circular.

The invention is also about a bundle 100 of gas cylinders 1. The bundle 100 comprises a frame 101 in which at least one gas cylinder 1 and shown a plurality of gas cylinders 1 is mounted in the said frame 101.

In FIG. 5, a first storing configuration is represented, and in which the gas cylinders 1 are positioned without any contact with each other and aligned in two directions.

In FIG. 6, a second storing configuration is represented, and in which the gas cylinders 1 are positioned without any contact with each other and aligned in one direction and positioned in the second direction in quincunx.

The fastening of the gas cylinders 1 in the frame 101 will now be described in reference with the FIGS. 8, 9 and 10.

The frame comprises at least an upper element 101a and a lower element 101b. As shown in FIGS. 8 and 9, the upper element 101a comprises housings 103 shaped and configured to receive the first end 3 of each gas cylinder 1.

In a variant of the invention, the lower element 101b comprises housings 104 shaped and configured to receive the second end 4 of each gas cylinder 1. Thanks to this arrangement, the gas cylinders and maintained in the frame without contact with each other, each housing 103 of the first element 101a being spaced from each other and each housing 104 of the second element 101b being spaced from each other.

The first fastening embodiment is represented in FIG. 8 and show that the housings 103 of the first element 101a of the frame are configured to receive the flange 3a of the first end 3 of each gas cylinder 1 and the housings 104 of the second element 101b are configured to receive directly the second end 4. In a variant of this first fastening embodiment and as shown in FIG. 10, a locking member 105 is positioned inside the housing of the second element 101b, preferably perpendicularly to the second end 4, in order to hold and block the position of the gas cylinder 1. For example, this locking member 105 can be a bolt and nut system or a tie rod or a pin.

The fastening second embodiment is represented in FIG. 9 and show that the housings 103 of the first element 101a of the frame are configured to receive the flange 3a of the first end 3 of each gas cylinder 1 and the housings 104 of the second element 101b are configured to received the flange 4b of the second end 4.

Obviously, the invention is not limited to the embodiments described and represented with the annexed figures. Modifications remain possible, in particular from the point of view of the constitution of the each element or by substitution of technical equivalents, without leaving for all that the scope of the invention.

1. Gas cylinder for gas under pressure comprising a cylindrical body which comprises:
a first end which is opened and configured to be equipped with a valve and a manifold and,
a second end, positioned at the opposite of the first end, the second end being closed or open,
wherein the second end is a blocking and indexing member of the gas cylinder, the said second end being configured to index angularly the gas cylinder in a frame, when the said gas cylinder is in a storing position in the frame.

2. Gas cylinder according to the claim 1, wherein the second end of the gas cylinder is integral with the body of the gas cylinder.

3. Gas cylinder according to claim 1, wherein the second end of the gas cylinder has a non-circular cross-section.

4. Gas cylinder according to claim 1, wherein the second end of the gas cylinder has a polygonal cross-section with multiple branches.

5. Gas cylinder according to claim 1, wherein the second end is full or hollow.

6. Gas cylinder according to claim 1, wherein the first end is provided with a flange, the said flange being an adaptor configured for blocking without indexing the gas cylinder in the vicinity of the first end.

7. Gas cylinder according to claim 1, wherein the second end of the gas cylinder is protruding from the body of the gas cylinder along a longitudinal axis of the body.

8. Gas cylinder according to the claim 7, wherein the protrusion of the second end represents approximately between at least 1% and 2% overall length of the gas cylinder.

9. Gas cylinder according to claim 1, wherein the second end of the gas cylinder is provided with a flange.

10. Bundle of gas cylinders comprising a frame in which at least one gas cylinder according to claim 1 is mounted, the said frame comprising at least one housing configured to receive the second end of the gas cylinder in order to maintain the said gas cylinder in the frame.

11. Bundle of gas cylinders according to the claim 10, wherein the said bundle of gas cylinders comprises at least a second gas cylinder for gas under pressure comprising a cylindrical body which comprises:
a first end which is opened and configured to be equipped with a valve and a manifold and,
a second end, positioned at the opposite of the first end, the second end being dosed or open,
wherein the second end is a blocking and indexing member of the second gas cylinder, the said second end being configured to index angularly the second gas cylinder in a frame, when the said second gas cylinder is in a storing position in the frame,
the second gas cylinder being mounted in the frame via its second end which is received in a second housing of the frame, the first gas cylinder and the second gas cylinder being maintained in the frame without contact with each other.

12. Bundle of gas cylinders according to the claim 11, each housing are spaced from each other.

13. Bundle of gas cylinders according to claim 11, wherein each housing are configured to cooperate by form complementarity with a second end of a gas cylinder.

14. Bundle of gas cylinders according to claim 10, wherein the frame comprises a first support comprising at least one hole configured to received the first end of at least one gas cylinder, a second support laid out approximately parallel to the first support and comprising at least one hole configured to receive the second end of the said at least one gas cylinder.

15. Bundle of gas cylinders according to claim 14, wherein, the first support and the second support are being connected to each other by at least one rigid fixation element.
